(19) United States
(12) Patent Application Publication
(10) Pub. No.: US 2002/0135246 A1
(43) Pub. Date: Sep. 26, 2002

(54) Protecting cap, especially for generators

(76) Inventors: Werner Lemke, Bietigheim-Bissingen (DE); Peter Skala, Bietigheim-Bissingen (DE)

Correspondence Address: Striker Striker & Stenby, 103 East Neck Road, Huntington, NY, 11743, US

(21) Appl. No.: 10/030,703

(22) PCT Filed: May 9, 2001
(86) PCT No.: PCT/DE01/01768

(30) Foreign Application Priority Data
May 18, 2000 (DE) 100 24 665.6

(51) Int. Cl. H02K 5/00; H02K 9/00

(52) U.S. Cl. 310/89; 310/58

(57) ABSTRACT

A cover, in particular for generators, having an intake stub (19) with an air inlet opening (40) is proposed, wherein the intake stub (19) forms an air guide (22) and has a connection (25) for a further intake element (28). The cover cap has a central axis (49), on the outer circumference (46) of the connection (25), that has a different direction from an air guide center line (52) in the region of the connection (25).

### PRIOR ART

From a publication of the Bosch corporation in the Technische Unterrichtung [Technical Instruction] series entitled “Generatoren” [“Generators”], 98/99 edition, a generator is known onto which a cover with an intake stub is mounted on one axial end. A hose is connected to this air intake stub, so that the generator is cooled solely by cool air from outside the engine compartment. While typically generators are cooled by air that has already been heated in the engine compartment by the internal combustion engine to a temperature level above the outdoor temperature, in this case air is aspirated from outside the engine compartment and is accordingly substantially cooler. The cooling action is thus better. Since the space in modern engine compartments is already very highly utilized, problems arise in arranging the hose connection, the hose, and the air guide that extends inside the hose connection.

### ADVANTAGES OF THE INVENTION

With the apparatus of the invention having the characteristics of the independent claim, not only can known geometries for the outer circumference of the connection be retained for a further intake element, such as a hose, but a streamlined air guide inside this connection is possible.

By means of the characteristics recited in the dependent claims, further advantageous features of the apparatus of the main claim are possible.

Because the axis of the outer circumference of the connection and the air guide center line intersect, it is possible, despite the sacrifice of a coaxial disposition of the air guide and the connection for the further intake element, to achieve the most favorable possible utilization of space for the air guide.

If the space conditions outside the cover are especially unfavorable, an air guide that is favorable from the standpoint of flow resistance is possible by designing the air guide center line in curved form.

By means of a conical course tapering in stepless fashion toward the middle of the cover, a targeted flow to temperature-critical components on the one hand and a streamlined course on the other are attained.

A still further-improved course of the air guide is attained by providing that the conical course of the air guide already begins at the air inlet opening. As a result, the space inside the connection for the further intake element is well utilized.

If a substantially cylindrical surface of the connection for the further intake element is conceived of in which the air guide extends conically, then between the surface of the connection and the conical course of the air guide a differential volume is obtained. In order not to cause an accumulation of material, such as what occurs in casting, there are ribs in this differential volume, which are arranged such that their envelope extends like the cylindrical surface of the connection. This has the advantage that while avoiding precisely this accumulation of material, nevertheless a substantially cylindrical bearing face for the further intake element is present, and as a result the sealing action between the further intake element and the outer circumference of the connection is unrestricted.

A favorable disposition for the ribs in terms of their support action for a hose to be slipped on is achieved if these ribs have recesses, in the form of a hexagonal honeycomb structure.

To obtain a secure hold of a hose to be slipped onto the outer circumference of the connection, annular-beadlike protrusions are disposed over at least part of the cylindrical surface of the connection.

### DRAWINGS

The invention will be described in further detail below in terms of an exemplary embodiment in conjunction with the associated drawings. Shown are:

FIG. 1, a three-dimensional view of the cover of the invention with the intake stub;

FIG. 2, a longitudinal section through the intake stub;

FIG. 3, a side view of the cover; and

FIG. 4, a plan view on the cover.

Components that are identical or have the same function are identified by the same reference numerals.

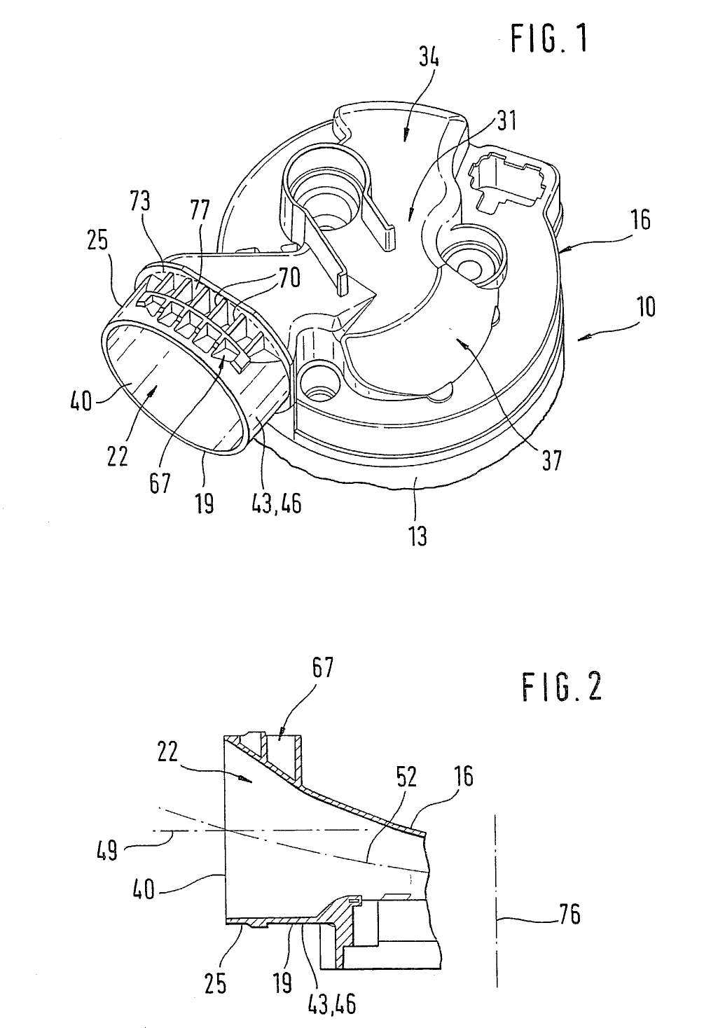

FIG. 1 shows a detail in elevation view of an axial end of a generator 10. A substantially cuplike cover 16 is placed on a bearing plate 13, which typically receives a bearing, not shown, for a claw pole rotor, also not shown. This cover 16 has an intake stub 19, which forms an air guide and has a connection 25 for a further intake element 28. The air guide 22 extends in the direction toward a middle 31 of the cover 16 and is divided up into two air guide conduits 34 and 37. The cooling air flowing through an air inlet opening 40 is passed through the air guide 22, and the cooling air stream splits into essentially two partial cooling air streams, which are conducted in a targeted way to temperature-critical components.

FIG. 2 shows a section through the air guide 22 of the kind shown in FIG. 4. It can be seen clearly that the air guide 22 has a conical, stepless course. The connection 25 of the intake stub 19 has a substantially cylindrical surface 43, onto which the further intake element 28 can be slipped and fastened. This essentially cylindrical surface 43 of the connection 25 forms the outer circumference 46 of the connection 25 and has a central axis 49. The essentially cylindrical surface 43 and the outer circumference 46 of the connection 25 can also be seen in FIG. 1. Corresponding to the conical course of the air guide 22, the result is an essentially central air guide center line 52, which is practically equivalent to a central flow line in the air guide 22. It can be seen clearly that the central axis 49 of the outer circumference 46 of the connection 25 has a different direction in the region of the connection from the air guide center line 52. This shaping of the air guide 22 in the region of the connection 25, because of its extensive independence of the cylindrical surface 43 of the connection 25, makes a streamlined design possible. A further characteristic of the air guide 22, or of its air guide center line 52, and of the central axis 49 is dictated by the fact that the axes 49 and the air guide center line 52 intersect. The conical course of the air guide 22, as can been seen in FIG. 2, already begins at the air inlet opening 40. The air guide 22 or air guide center line 52 extends in a streamlined, curved fashion in the direction of the middle of the cover 16.

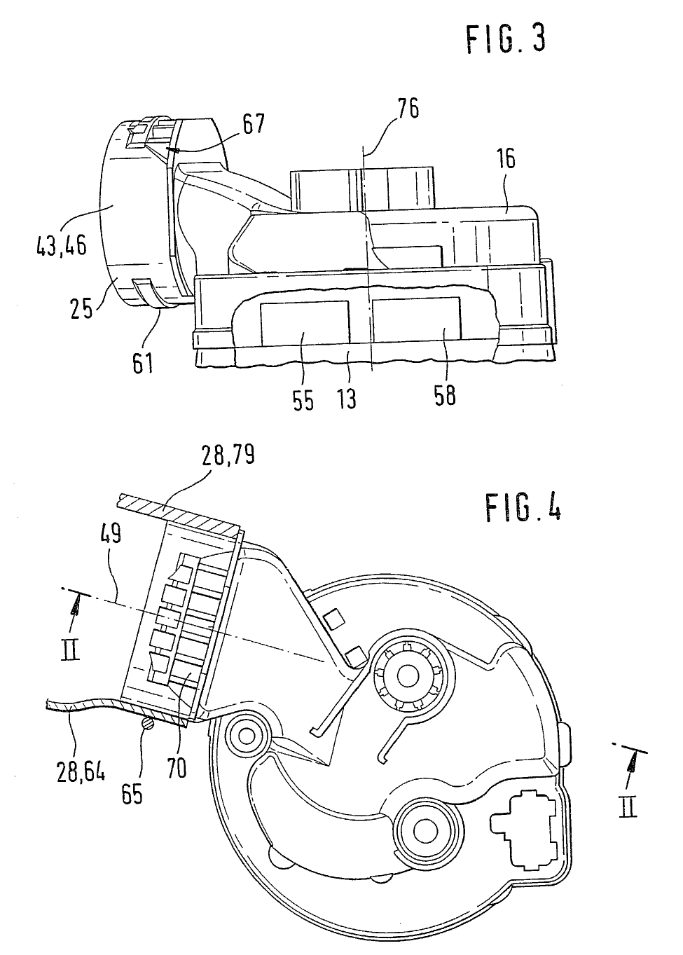

FIG. 3 shows a side view of the cover 16 of the invention on the bearing plate 13. A regulator 55 and a rectifier 58, here represented symbolically, are disposed between the bearing plate 13 and the cover 16. Because the cover 16 has only a single air entrance in the form of the air guide 22, and the cooling air stream can be aimed in a targeted way, it is possible to cool the regulator 55 and rectifier 58 in a targeted, effective way. Annular-beadlike protrusions 61 extend on the connection 25 or its outer circumference 46 and serve to clamp a slipped-on hose 64 from the direction of its inside. In cooperation with a hose clamp 65 or some similar assembly element, it is therefore possible to obtain a good, secure connection of a hose 64 to the intake stub 19; see also FIG. 4. To prevent excessively strong clamping between the hose 64 and the intake stub 19 or connection 25 while the hose is being slipped on, the annular-beadlike protrusions 61 extend over only part of the cylindrical surface 43.

Because a conical air guide 22 is disposed inside the cylindrical surface 43 of the connection 25, a so-called differential volume 67 is created here in the cover 16, on the surface of the air guide 22 remote from the bearing plate 13. The differential volume 67 can be described by stating that this involves the difference between the cylindrical part of the connection 25 and the conical part of the air guide 22 over the length of the connection 25. In FIG. 2, this differential volume can be seen from the triangular surface between the cylindrical surface 43 and the air guide 22 over the length of the connection 25. It can also be seen in FIG. 3 and in FIG. 1. In the region of this differential volume, there are ribs 70, which for instance brace a hose 64 from inside and thus assure a substantially cylindrical bearing face corresponding to the cylindrical surface 43. The ribs are disposed such that an envelope 73, indicated in FIG. 1, extends like the cylindrical surface 43 of the connection 25. The ribs 70 are disposed parallel to an axis 76 of the cover 16. Some of the ribs 70 extend essentially in the direction of the air guide 22; a further rib 70 extends in the circumferential direction of the cylindrical surface 43. In the process, these ribs 70 enclose honeycomblike recesses 77. This leads to adequate stability of the intake stub 19 or of the connection 25 in the region of the differential volume 67 and also leads to a secure bearing face, providing good support, of the hose 64.

FIG. 4 shows a plan view on the cover 16 or its intake stub 19. Various further intake elements 28 can be connected to such a connection 25. For instance, a hose can be connected, as shown in the lower part of the connection 25, or a tube 79, as shown in the upper part of the connection 25.

The honeycomblike recesses that are enclosed by the ribs 70 can be not merely rectangular, as shown for instance in FIG. 1 or FIG. 4, but also can have a hexagonal honeycomb structure, for instance.

1. A cover, in particular for generators, having an intake stub (19) with an air inlet opening (40), wherein the intake stub (19) forms an air guide (22) and has a connection (25) for a further intake element (28), characterized in that an outer circumference (46) of the connection (25) has a central axis (49), which has a different direction from an air guide center line (52) in the region of the connection (25).

2. The cover of claim 1, characterized in that the axis (49) of the outer circumference (46) of the connection (25) and the air guide center line (52) intersect.

3. The cover of claim 2, characterized in that the air guide center line (52) is curved.

4. The cover of one of the foregoing claims, characterized in that the air guide (22) has a conical, stepless course tapering toward a center of the cover (16).

5. The cover of claim 4, characterized in that the conical course of the air guide (22) begins at the air inlet opening (40).

6. The cover of one of the foregoing claims, characterized in that between a substantially cylindrical surface (43) of the connection (25) for the further intake element (28) and the conical course of the air guide (22), a differential volume (67) is present, in which ribs (70) are disposed such that their envelope (73) has the same course as the cylindrical surface (43) of the connection (25).

7. The cover of claim 6, characterized in that the ribs (70) enclose honeycomblike recesses (77).

8. The cover of one of the foregoing claims, characterized in that annular-beadlike protrusions (61) extend over at least a portion of the cylindrical surface (43) of the connection (25).

9. The cover of one of the foregoing claims, characterized in that a tube (79) or hose (64) can be secured as a further intake element (28) to the connection (25).

10. The cover of one of the foregoing claims, characterized in that the cover (16) covers a regulator (55) and a rectifier (58).
